(19) United States
(12) Patent Application Publication
(10) Pub. No.: US 2001/0021687 A1
(43) Pub. Date: Sep. 13, 2001

(54) Solid catalyst component and catalyst for olefin polymerization, and method for producing olefin polymer

(76) Inventors: Shin-Ichi Kumamoto, Ichihara-shi (JP); Eiji Nakaishi, Sodegaura-shi (JP); Makato Satoh, Ichihara-shi (JP)

Correspondence Address: Stevens, Davis, Miller & Mosher, LLP, 1615 L Street, NW, Suite 850, Washington, DC, 20036, US

(21) Appl. No.: 09/852,012

(22) Filed: May 10, 2001

Related U.S. Application Data
(62) Division of application No. 09/139,263, filed on Aug. 25, 1998.

(30) Foreign Application Priority Data
Sep. 2, 1997 (JP) 09-236765

(51) Int. Cl. B01J 31/00

(52) U.S. Cl. 502/125; 502/102; 502/103; 502/104; 502/118; 502/127

(57) ABSTRACT

A solid catalyst component for olefin polymerization obtained by contacting a titanium compound having a titanium-halogen bond and an ester compound simultaneously, or a mixture of a titanium compound (A) having a titanium-halogen bond and an ester compound (B), with a solid catalyst component precursor (C) containing a magnesium atom, a titanium atom and a hydrocarbyloxy group.

According to the present invention, there is provided a solid catalyst component for olefin polymerization having an excellent particle form and giving a high polymerization activity per solid catalyst component and a olefin polymer excellent in powder property.

### BACKGROUND OF THE INVENTION

1. Field of the Invention

The present invention relates to a solid catalyst component for olefin polymerization, a catalyst for olefin polymerization, and a method for producing an olefin polymer. More particularly, the present invention relates to a solid catalyst component for olefin polymerization, a catalyst for olefin polymerization, and a method for producing an olefin polymer, suitable for gas phase polymerization and slurry polymerization processes.

The olefin polymer in the present invention contains a homopolymer of an olefin and a copolymer of an olefin with another olefin.

### DESCRIPTION OF THE RELATED ARTS

When the activity of a catalyst (polymerization amount per unit catalyst) used in the production of an olefin polymer is sufficiently high, it is needless to say that the utility value thereof is industrially extremely high since there is no need to remove a catalyst residue from a polymer produced after the polymerization and thus the production process of the polymer can be simplified.

On the other hand, since much adhesion of a polymer and the like to a polymerization vessel causes to generate various problems in operation and reduce operational efficiency, it is desirable that adhesion of a polymer and the like to a polymerization vessel is as low as possible. In view of operational stability and operational efficiency, it is desirable that the bulk density of a polymer powder is high, the particle size distribution is narrow, and the flowability is excellent. Further, the existence of a low molecular weight component in a polymer is a factor controlling the transparency, impact resistance, blocking property of a film, therefore, it is desirable to produce an olefin polymer containing a small amount of a low molecular weight component.

Recently, in the field of a catalyst for olefin polymerization, polymerization activity has been markedly improved by a combination of a magnesium compound with a titanium compound (e.g. JP-B-46-34092, JP-B-47-41676, JP-B-55-23561, JP-B-57-24361). However, an olefin polymer produced by using these catalysts has not been satisfactory in the points of particle property and blocking property

It is disclosed that a polymer of high crystallinity can be produced with a high activity by using a catalyst obtained by treatment with an oxygen-containing electron donor and the like such as an ester and the like as an internal donor in stereoregular polymerization of propylene (e.g. JP-B-52-39431, 52-36786, 1-28049, and 3.-43283). However, olefin polymers obtained by conducting copolymerization of ethylene with an α-olefin using these catalysts have not been satisfactory in the points of particle properties and blocking property as described above.

### SUMMARY OF THE INVENTION

An object of the present invention is to provide a solid catalyst component for olefin polymerization having excellent particle form, a catalyst for olefin polymerization having so high polymerization activity per catalyst that removal of a catalyst residue is not necessary, and a method for producing an olefin polymer having excellent particle properties and containing a small amount of a lower molecular weight component, with the catalyst.

The present inventors have been studied intensively these problems and completed the present invention.

Namely, the present invention provides to a solid catalyst component for olefin polymerization obtained by contacting a titanium compound (A) having a titanium-halogen bond and an ester compound (B) simultaneously with a solid catalyst component precursor (C) containing a magnesium atom, titanium atom and a hydrocarbyloxy group, and a solid catalyst component for olefin polymerization obtained by contacting a mixture of a titanium compound (A) having a titanium-halogen bond and an ester compound (B) with a solid catalyst component precursor (C) containing a magnesium atom, titanium atom and a hydrocarbyloxy group. Further, the present invention provides to a catalyst for olefin polymerization which comprises said solid catalyst component for olefin polymerization (I) and an organoaluminum compound (II), and a method for producing an olefin polymer, which comprises polymerizing an olefin with said catalyst for olefin polymerization.

### BRIEF DESCRIPTION OF THE DRAWING

FIG. 1 is a flow chart for helping understanding of the present invention. This flow chart is a typical example of the embodiments of the present invention, and the present invention is not limited by this example at all.

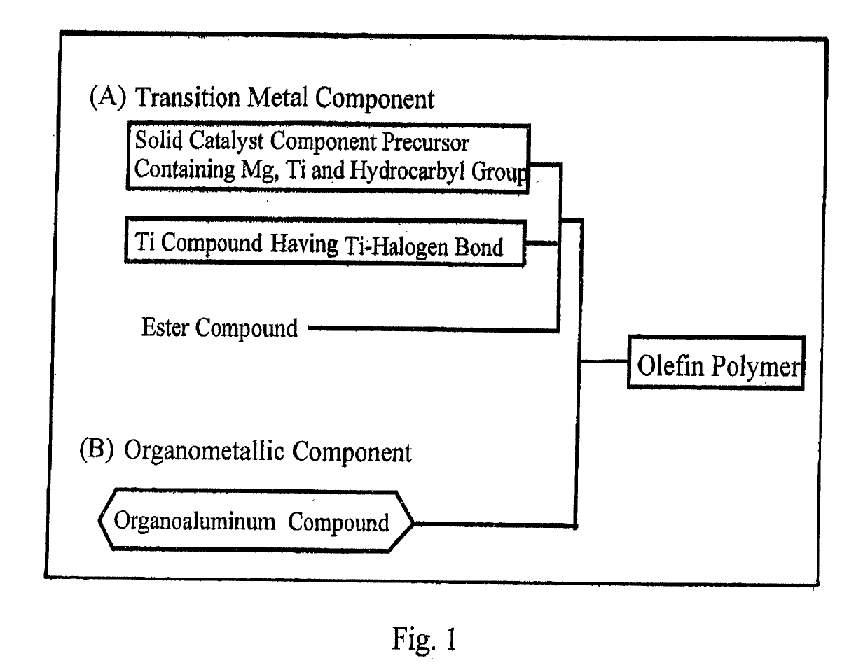

### DETAILED DESCRIPTION OF THE INVENTION

The present invention will be described specifically below.

[Solid Catalyst Component for Olefin Polymerization]

The solid catalyst component (I) for olefin polymerization of the present invention is a solid catalyst component for olefin polymerization obtained by contacting a titanium compound having a titanium-halogen bond (A) and (B) an ester compound simultaneously with a solid catalyst component precursor containing a magnesium atom, titanium atom and a hydrocarbyloxy group (C), or by contacting a mixture of a titanium compound having a titanium-halogen bond (A)and an ester compound (B) with a solid catalyst component precursor containing a magnesium atom, titanium atom and a hydrocarbyloxy group (C).

As the titanium compound (A) having a titanium-halogen bond (A) used in the present invention is preferably a titanium compound having at least one Ti—Cl bond. Specifically, titanium halides, titanium halide alkoxides, titanium halide amides and the like are listed, and titanium tetrachloride is particularly preferable in the point of polymerization activity.

As the ester compound (B) used in the present invention, mono- or poly-valent carboxylic acid esters are preferably used, and examples thereof include saturated or unsaturated aliphatic carboxylic acid esters, alicyclic carboxylic acid esters, aromatic carboxylic acid esters and the like. Specific examples thereof include methyl acetate, ethyl acetate, phenyl acetate, methyl propionate, ethyl propionate, ethyl butyrate, ethyl valerate, methyl acrylate, ethyl acrylate, methyl methacrylate, ethyl benzoate, n-butyl benzoate, isobutyl benzoate, methyl toluate, ethyl toluate, ethyl anisate, diethyl succinate, di-n-butyl succinate, diisobutyl succinate, diethyl malonate, di-n-butyl malonate, diisobutyl malonate, dimethyl maleate, di-n-butyl maleate, diisobutyl maleate, diethyl itaconate, di-n-butyl itaconate, diisobutyl itaconate, monoethyl phthalate, dimethyl phthalate, methyl ethyl phthalate, diethyl phthalate, di-n-propyl phthalate, diisopropyl phthalate, di-n-butyl phthalate, diisobutyl phthalate, di-n-octyl phthalate, diphenyl phthalate and the like.

Among these ester compounds, unsaturated aliphatic carboxylic acid esters such as methacrylates, maleates and the like, or aromatic carboxylic acid esters such as phthalates and the like are preferred, and aromatic carboxylates are more preferred, and diesters of phthalic acid are particularly preferred.

The solid catalyst component precursor (C) used in the present invention is a solid component containing a magnesium atop, a titanium atom and a hydrocarbyloxy group. Specifically, a solid product obtained by reducing a titanium compound (2) represented by the general formula Ti(OR¹)ₐX₄₋ₐ (wherein R¹ represents a hydrocarbon group having 1 to 20 carbon atoms, X represents a halogen atom, “a” is a number satisfying 0<a≦4) with an organomagnesium compound (3) in the presence of an organosilicon compound (1) having a Si—bond, disclosed in JP-B-3-043283, and a solid product obtained by reducing a titanium compound (2) represented by the general formula Ti(OR¹)ₐX₄₋ₐ (wherein R¹, X and “a” are as defined above) with an organomagnesium compound (3) in the presence of an organosilicon compound (1) having a Si—O bond and a porous carrier (4), disclosed in JP-B-4-057685, are preferable.

Specific examples of R¹ in the titanium compound (2) represented by the above general formula, include alkyl groups such as a methyl group, ethyl group, n-propyl group, iso-propyl group, n-butyl group, iso-butyl group, amyl group, iso-amyl group, n-hexyl group, n-heptyl group, n-octyl group, n-decyl group, n-dodecyl group and the like, aryl groups such as a phenyl group, cresyl group, xylyl group, naphthyl group and the like, cycloalkyl groups such as a cyclohexyl group, cyclopentyl group and the like, allyl groups such as a propenyl group and the like, aralkyl groups such as a benzyl group and the like.

Among these groups, alkyl groups having 2 to 18 carbon atoms or aryl groups having 6 to 18 carbon atoms are preferable. Particularly, straight-chain alkyl groups having 2 to 18 carbon atoms are preferable. It is also possible to use a titanium compound having two or more different OR¹ groups.

As the halogen atom represented by X, a chlorine atom, bromine atom and iodine atom can be exemplified. Particularly, a chlorine atom gives preferable result.

The “a” is a number satisfying 0<a≦4, preferably 2≦a≦4, more preferably a=4.

For synthesizing the titanium compound (2), known methods can be used. For example, there can be used a method in which Ti(OR¹)₄ and TiX₄ are reacted in a predetermined ratio, a method in which TiX₄ and the corresponding alcohol (for example, R¹OH) and the like are reacted in a predetermined amount.

As the organic silicon compound (1) having a Si—O bond, following compounds are listed.

Si(OR³)_{b}R4_{4-b}

R⁵(R⁶₂SiO)cSiR⁷₃,

or

(R⁸₂SiO)_{d}

R³ represents a hydrocarbon group having 1 to 20 carbon atoms, R⁴, R⁵, R⁶, R⁷ and R⁸ represent a hydrocarbon group having 1 to 20 carbon atoms or a hydrogen atom, b is a number satisfying 0<b≦4, c represents an integer from 1 to 1000, and d represents an integer from 2 to 1000.

Specific examples of the organic silicon compound include tetramethoxysilane, dimethyldimethoxysilane, tetraethoxysilane, triethoxyethylsilane, diethoxydiethylsilane, ethoxytriethylsilane, tetra-iso-propoxysilane, di-iso-propoxy-di-iso-propylsilane, tetra-n-propoxysilane, di-n-propoxydi-n-propylsilane, tetra-n-butoxysilane, tetra-iso-butoxysilane, di-n-butoxydi-n-butylsilane, di-iso-butoxydi-iso-butylsilane, dicyclopentoxydiethylsilane, diethoxydiphenylsilane, cyclohexyloxytrimethylsilane, phenoxytrimethylsilane, tetraphenoxysilane, triethoxyphenylsilane, hexamethyldisiloxane, hexaethyldisiloxane, hexa-n-propyldisiloxane, hexaisopropyldisiloxane, octaethyltrisiloxane, poly(dimethylsiloxane) poly(diphenylsiloxane), poly(methylhydrosiloxane), poly(phenylhydrosiloxane) and the like.

Among these organic silicon compounds, alkoxysilane compounds represented by the general formula Si(OR³)_{b}R⁴_{4-b}, are preferable, the alkoxysilane compounds satisfying 1<b≦4 are more preferable, and tetraalkoxysilane compounds in which b is 4, are particularly preferable.

As the organomagnesium compound (3), any types of organomagnesium compounds having a magnesium-carbon bond can be used. Particularly, Grignard compounds represented by the general formula R⁹MgX (wherein R⁹ represents a hydrocarbon group having 1 to 20 carbon atoms and X represents a halogen atom.), or dialkyl magnesium compounds represented by the general formula R¹⁰R¹¹Mg (wherein R¹⁰ and R¹¹ represent a hydrocarbon group having 1 to 20 carbon atoms) or diaryl magnesium compounds and the like are preferably used. R¹⁰ and R¹¹ may be the same or different. Specific examples of R⁹ to R¹¹ include alkyl groups having 1 to 20 carbon atoms, aryl groups having up to 20 carbon atoms, aralkyl groups having up to 20 carbon atoms, and alkenyl groups having up to 20 carbon atoms, such as a methyl group, ethyl group, n-propyl group, iso-propyl group, n-butyl group, sec-butyl group, tert-butyl group, iso-amyl group, n-hexyl group, n-octyl group, 2-ethylhexyl group, phenyl group, benzyl group and the like. Particularly, it is preferable to use a Grignard compound represented by R⁹MgX in the form of an ether solution in viewpoint of catalytic ability.

It is also possible to use a hydrocarbon soluble complex of the above-described organomagnesium compound with organometallic compound which solubilizes the organomagnesium compound in a hydrocarbon. Examples of the organometallic compounds include organic compounds of Li, Be, B, Al or Zn.

As the porous carrier (4) optionally used, known porous carriers may be used. There are listed porous inorganic oxides represented by SiO₂, Al₂O₃, MgO, TiO₂, ZrO₂ and the like, and organic porous polymer such as polystyrene, styrene-divinylbenzene copolymer, styrene-ethylene glycol dimethacrylate copolymer, polymethylacrylate, polyethylacrylate, methylacrylate-divinylbenzene copolymer, polymethylmethacrylate, methylmethacrylate-divinylbenzene copolymer, polyacrylonitrile, acrylonitrile-divinylbenzene copolymer, polyvinyl chloride, polyethylene, polypropylene and the like. Among them, a styrene-divinylbenzene copolymer or acrylonitrile-divinylbenzene copolymer is preferably used.

The porous carrier has a volume of micro pores (micro pore volume) having a micro pore radius from 200 to 2000 Å of preferably 0.3 cc/g or more, more preferably 0.4 cc/g or more, and it is preferably 35% or more, more preferably 40% or more of the volume of micro pores having a micro pore radius from 35 to 75000 Å. When the micro pore volume of the porous substance is too small, a catalyst component is not sometimes fixed effectively. Further, even when the micro pore volume of the porous carrier is 0.3 cc/g or more, a catalyst component is not sometime fixed effectively unless such pores exist sufficiently in the range of micro pore radius from 200 to 2000 Å.

As a method for reducing a titanium compound with an organomagnesium compound, there are listed a method in which an organomagnesium compound (3) is added to a mixture of a titanium compound (2) and an organosilicon compound (1), and a inverse method thereof, and a porous carrier (4) may exist in these methods.

The titanium compound (2) and the organosilicon compound (1) are preferably dissolved or diluted in a suitable solvent for use.

Examples of such solvents include aliphatic hydrocarbons such as hexane, heptane, octane, decane and the like, aromatic hydrocarbons such as toluene, xylene and the like, alicyclic hydrocarbons such as cyclohexane, methylcyclohexane, decalin and the like, and ether compounds such as diethyl ether, di-n-butyl ether, diisoamyl ether, tetrahydrofuran and the like.

The reduction temperature is usually from −50 to 70° C., preferably from −30 to 50° C., mere preferably from −25 to 35° C.

The dropping time is not particularly restricted, and usually from about 30 minutes to 6 hours. After completion of the reduction, post reaction may also be further conducted at a temperature from 20 to 120° C.

The amount of the organosilicon compound (1) used is usually from 1 to 500, preferably from 1 to 300, more preferably from 3 to 100 in terms of atomic ratio Si/Ti of the silicon compound to a titanium atom in the titanium compound (2).

The amount of the organomagnesium compound (3) used is usually from 0.1 to 10, preferably from 0.2 to 5.0, more preferably from 0.5 to 2.0 in terms of atomic ratio (Ti+Si)/Mg) of the Sum of a titanium atom and a silicon atom to a magnesium atom.

The amounts used of the titanium compound (2), organosilicon compound (1) and organomagnesium compound (3) may be determined so that the molar ratio of Mg/Ti in the solid catalyst component (I) is within the range of 1 to 51, preferably 2 to 31, more preferably 4 to 26.

The solid product obtained by the reduction is subjected to solid-liquid separation, and washed several times with an inert hydrocarbon solvent such as hexane, heptane or the like.

Thus obtained solid catalyst component precursor (C) contains a trivalent titanium, magnesium and hydrocarbyloxy group, and generally shows amorphous or extremely low crystallinity.

The solid catalyst component (I) is obtained by contacting a titanium compound (A) having a titanium-halogen bond and an ester compound (B) simultaneously with the solid catalyst component precursor (C) containing a magnesium atom, titanium atom and a hydrocarbyloxy group obtained by the above-described method. Specifically, there are listed a method in which a mixture obtained by previously mixing (A) with (B) is added to (C), a method in which (A) and (B) are successively added to (C) and treated, a method in which (A) and (B) are simultaneously added to (C) and treated, and methods in which these components are added inversely and treated, and the like.

A solid catalyst component obtained by a method in which (A) or (B) is contacted with (C), and after a operation such as washing and the like, the remaining (B) or (A) is subjected to contact treatment is not preferable, since when it is used in polymerization, effect for improving blocking property and particle property of a produced polymer is not sufficient.

A method in which a mixture obtained by previously mixing (A) with (B) is added to (C) and treated is preferable. The above-described operation may be repeated twice or more, and after the above-described operation, (A) or (B) may be further contacted with the treated solid.

The amount of the titanium compound (A) used is usually 0.1 to 1000 millimol, preferably from 0.3 to 500 millimol, more preferably from 0.5 to 300 millimol per 1 g of the solid catalyst component precursor (C).

All of the titanium compound (A) may be used in one contacting treatment, however, it may also be divided and used in any plural times of treatments.

The amount of the ester compound (B) used is usually 0.1 to 1000 millimol, preferably from 0.3 to 500 millimol, particularly preferably from 0.5 to 300 millimol per 1 g of the solid catalyst component precursor (C).

All of the ester compound (B) may be used in one treatment, however, it may also be divided and used in any plural times of treatments.

The molar ratio of the ester compound (B) to the titanium compound (A) is preferably from 0.05 to 50, more preferably from 0.1 to 10 when (A), (B), (C) are simultaneously subjected to contact treatment.

The treatment of the solid catalyst component precursor (C) with the titanium compound (A) and ester compound (B) can be conducted by any known method which can contact both components such as a slurry method, mechanical pulverizing means (e.g. ball mill) or the like. However, it is preferable that the both components are contacted in the presence of a diluent (slurry method) because of obtaining a solid catalyst component narrow in particle size distribution.

Further, after the treatment, the following treatment may be conducted directly, however, for removing an unreacted reagent, washing operation may be repeated for any times using a diluent.

The diluent is preferably inert to the solid component treated, and there can be used aliphatic hydrocarbons such as pentane, hexane, heptane, octane and the like, alicyclic hydrocarbons such as benzene, toluene, xylene and the like, and halogenated hydrocarbons such as 1,2-dichloroethane, monochlorobenzene and the like.

The amount of the diluent used is usually from 0.1 ml to 1000 ml per 1 g of the solid catalyst component precursor (C). It is preferably from 1 ml to 100 ml per 1 g.

The treatment and washing temperature is usually from −50 to 150° C., and preferably from 0 to 120° C.

The treatment and washing time is not particularly restricted, and preferably from 0.5 to 6 hours.

The solid catalyst component (I) obtained by the above-described method may be used for polymerization in the form of a slurry in the presence of a diluent, or after properly dried, may be used for polymerization in the form of a flowable powder.

[Catalyst for Olefin Polymerization]

The catalyst for olefin polymerization used in the present invention comprises the solid catalyst component (I) obtained by the above-described method and an organoaluminum compound (II).

The organoaluminum compound (II) has at least one Al-carbon bond in the molecule.

Typical examples thereof are shown below.

R¹²AlY₃₋ᵣ

R¹³R¹⁴Al—(O—AlR¹⁵)_{d}R¹⁶

R¹², R¹³, R¹⁴, R¹⁵ and R¹⁶, each independently, represent a hydrocarbon group having 1 to 8 carbon atoms, Y represents a halogen atom, hydrogen atom or alkoxy group. R represents a number defined by 2≦r≦3. d represents a number defined by 1≦d≦30.

Specific examples of the organoaluminum compound include trialkylaluminums such as tri-n-butylaluminum, triisobutylaluminum, tri-n-hexylaluminum and the like, dialkylaluminum halides such as diethylaluminum chloride, di-n-butylaluminum chloride, diisobutylaluminum chloride and the like, dialkylaluminum hydrides such as diethylaluminum hydride, di-n-butylaluminum hydride, diisobutylaluminum hydride and the like, mixtures of trialkylaluminums with dialkylaluminum halides, alkylalumoxanes such as tetraethyldialumoxane, tetra-n-butyldialumoxane, tetra-iso-butyldialumoxane, polymethylalumoxane, polyethylalumoxane and the like.

Of these organoaluminum compounds, trialkylaluminums; mixtures of trialkylaluminums with dialkylaluminum halides; or alkylalumoxanes are preferred, and among other, triethylaluminum, tri-n-butylaluminum, triisobutylaluminum, tri-n-hexylaluminum, a mixture of triethylaluminum with diethylaluminum chloride, or tetraethyldialumoxane are preferred.

The amount used of the organoaluminum compound (II) can be usually selected in wide range such as from 1 to 1000 mol per 1 mol of a titanium atom in the solid catalyst component (I), and it is preferably in the range from 5 to 600 mol.

[Prepolymerization]

The solid catalyst component (I) in the present invention can be used in polymerization as it is, and it may also be used in main polymerization (referred to simply as “polymerization” hereinafter) after conducting prepolymerization before polymerization. The prepolymerization is conducted by contacting the solid catalyst component (I) for olefin polymerization with the organoaluminum compound (II) and an olefin.

As the olefin, ethylene, propylene, butene-1 and the like are listed. The prepolymerization can be any of homopolymerization and copolymerization.

For obtaining a prepolymer having a high crystallinity, a known electron donor and hydrogen may be allowed to exist. As the electron donor, organic compounds having a Si—OR bond (wherein R represents a hydrocarbon having 1 to 20 carbon atoms) are preferably used.

In conducting prepolymerization of the solid catalyst component (I) of the present invention, (I) is preferably made into slurry, and examples of the solvent used for slurrying include aliphatic hydrocarbons (e.g. butane, pentane, hexane, heptane), aromatic hydrocarbons (e.g. toluene, xylene), and the like.

The slurry concentration is usually from 0.001 to 0.5 g-solid/ml-solvent, preferably 0.01 to 0.3 g-solid/ml-solvent. It is preferable to use the organoaluminum compound so that the molar ratio Al/Ti is from 0.1 to 100, particularly from 1 to 10.

The prepolymerization temperature is usually from −30 to 80° C., preferably from −10 to 50° C.

The prepolymerization amount is usually from 0.1 to 100 g, preferably from 0.5 to 50 g per 1 g of the solid catalyst component (I).

[Method for Producing Olefin Polymer]

In the present invention, one olefin can be homopolymerized or two or more olefins can be copolymerized using the solid catalyst component or prepolymerized solid catalyst component, and organoaluminum compound.

More specific embodiments of polymerization are shown below.

For supplying the solid catalyst component and organoaluminum compound into a polymerization vessel, there is no restriction except that they are supplied under moisture-free condition by using an inert gas (e.g. nitrogen, argon), hydrogen, olefin and the like.

The solid catalyst component and organoaluminum compound may be separately supplied or supplied after previously contacted.

The polymerization can be conducted by a known method such as a usual gas-phase polymerization, slurry polymerization or the like.

It is preferable to conduct the polymerization usually at lower temperature than the point the polymer is melted, preferably from 20 to 100° C., more preferably from 40 to 90° C., under a pressure in the range from normal pressure to 40 kg/cm². Further, in the polymerization, for the purposed of controlling the melt flowability of the final product, hydrogen can be added as a molecular weight controller for polymerization. The polymerization can be conducted by a continuous method or batch-wise method.

Olefins used in the polymerization has two or more carbon atoms, and specific examples thereof include ethylene, propylene, butene-1, pentene-1, hexene-1, 3-methyl-pentene-1, 4-methylpentene-1 and the like.

In the present invention, homopolymerization of an olefin or copolymerization of two or more olefins can be conducted. Particularly, copolymerization of ethylene with one or two or more α-olefins having 3 or more carbon atoms is preferable. In this case, an ethylene copolymer can be produced by contacting ethylene and one or more α-olefins in mixed state with the catalyst.

### EXAMPLE

The following examples illustrate the present invention in detail below, but do not limit the scope thereof.

The properties of polymers in examples were measured by the following methods.

(1) Content of an α-olefin

A calibration curve was prepared from characteristic absorptions of ethylene and the α-olefin measured by using an infrared spectrophotometer (1600 series, manufactured by Perkin Elmer Ltd.), and the content of α-olefin were determined using the calibration curve. The content is shown in terms of short chain branch number (SCB) per 1000 c. (2) The flowrate (FR) was measured according to ASTMD1238. (3) The flow rate ratio (FRR) was adopted as a measure for melt fluidity. FRR is shown in terms of ratio to flow rate (FR) when 21.60 kg of load is applied in a measuring method of flow rate (FR) according to ASTM D1238.

FRR=(flow rate when load is 21.60 kg)÷(flow rate when load is 2.160 kg)

It is known, in general, that when the molecular weight distribution of a polymer is wider, the value of FRR is larger.

(4) The lower molecular weight component amount was evaluated by content of portion extracted with a cold xylene at 25° C. (CXS) in the total polymer.

(5) Regarding the composition analysis, Mg, Ti and Cl were analyzed by ICP emission analysis using Optima 3000 manufactured by Perkin Elmer Ltd., and alcohol was analyzed by gas chromatograph GC-7A (manufactured by Shimadzu Corporation) (PEG 6000 10%, SHTMALITE TPA 60/80).

### Example 1

(1) Synthesis of Solid Catalyst Component Precursor (C)

A flask having an inner volume of 500 ml equipped with a stirrer and dropping funnel was purged with nitrogen, then, 160 ml of hexane, 44 ml (196.4 mol) of tetraethoxysilane and 4.4 ml (12.9 mol) of tetra-n-butoxytitanium were charged, and the mixture was stirred at 30° C. for 30 minutes. Then, 100 ml of n-butylmagnesium chloride (di-n-butyl ether solution 2.1 mol/l) was dropped from a dropping funnel over 1 hour while maintaining the temperature of the flask at 5° C. After completion of the dropping, the mixture was stirred at 5° C. for 1 hour, and additionally stirred for 1 hour at 20° C., then, filtered, washed with 200 ml of hexane three times and dried under vacuum, to obtain 31.2 g of a brown solid product (solid catalyst component precursor (C)).

The resulting solid product contained 16.5 wt % of Mg, 1.91 wt % of Tit 36.4 wt % of OEt(ethoxy group) and 2.93 wt % of OBu(butoxy group).

(2) Synthesis of Solid Catalyst Component (I)

A flask having an inner volume of 50 ml equipped with a stirrer and dropping funnel was purged with nitrogen then, 17.5 ml of toluene, 3.5 ml (31.9 mmol) of TiCl₄ and 4.3 ml (16.0 mmol) diisobutyl phthalate (hereinafter, abbreviated as DIBP) were charged, and the mixture was stirred at 70° C. for 1 hour. A flask having an inner volume of 100 ml equipped with a stirrer and dropping funnel was purged with nitrogen, then, 17.5 ml of toluene and 7.00 g of the solid catalyst component precursor (C) Synthesized in the above-described procedure (1) were charged, and the mixture was kept at 70° C. for 30 minutes, then, the whole mixture of TiCl₄ and DIBP previously prepared was charged, and the resulting mixture was stirred for 3 hours at 95° C. After stirring, the mixture was subjected to solid-liquid separation, washed with 35 ml of toluene three times at 95° C., to this 35 ml of toluene was added again. After heated to 70° C., 3.5 ml (31.9 mmol) of TiCl₄ was added, and the mixture was stirred for 1 hour at 95° C. After stirring, solid-liquid separation was conducted, and the resulting solid was washed with 35 ml of toluene seven times at 95° C., with 35 ml of hexane twice at room temperature, and dried under vacuum to obtain a solid catalyst component (I) excellent in powder property.

The resulted solid product contained 2.0 wt % of Ti.

(3) Polymerization

An autoclave having an inner volume of 3 liter equipped with a stirred was dried thoroughly, and the pressure was reduced to vacuum, then, 1.2 kg/cm² (partial pressure) of hydrogen, 600 g of butane and 150 g of 1-butene were charged, and the mixture was heated to 70° C. Then, ethylene was added so that the partial pressure was 6.0 kg/cm². 5.7 millimol of triethylaluminum and 17.5 mg of the solid catalyst component (I) obtained in the above-described procedure (2) were charged with argon pressure, and polymerization was initiated. Then, polymerization was carried out at 70° C. for 3 hours while maintaining the total pressure constant supplying ethylene continuously.

After completion of the polymerization, unreacted monomers were purged, and 99 g of a polymer having an excellent powder property was obtained. The polymer did not adhere to the inner wall of the autoclave and the stirrer at all.

The amount produced of the polymer per catalyst (polymerization activity) was 1900 g polymer/g solid catalyst component/hr. This polymer had 15.2 of SCB, 0.59 of FR, 23.0 of FRR and 4.7 wt % of CXS, namely, small content of lower molecular weight components.

### Example 2

(1) Synthesis of Solid Catalyst Component (I)

Synthesis was conducted in the same manner as in Example 1(2) except that 2.3 ml (8.6 mmol) of di-n-butyl phthalate (hereinafter, abbreviated as DNBP) was used as an ester compound instead of DIBP, to obtain a solid catalyst component (I) excellent in powder property.

The resulting solid product contained 3.5 wt % of Ti.

(2) Polymerization

The solid catalyst component obtained in the above-described procedure (1) was used, and polymerization was conducted in the same manner as in Example 1(3), to obtain a polymer having an excellent powder property. The polymer did not adhere to the inner wall of the autoclave and the stirrer at all.

The polymerization activity was 1400 g polymer/g solid catalyst component/hr. This polymer had 13.3 of SCB, 0.49 of FR, 28.6 of FRR and 4.1 wt % of CXS, namely, small content of lower molecular weight components.

### Example 3

(1) Synthesis of Solid Catalyst Component (I)

Synthesis was conducted in the same manner as in Example 1(2) except that 2.6 ml (11.2 mmol) of diisopropyl phthalate (hereinafter, abbreviated as DIPP) was used as an ester compound instead of DIBP, to obtain a solid catalyst component (I) having excellent in powder property.

The resulting solid product contained 4.7 wt % of Ti.

(2) Polymerization

The solid catalyst component obtained in the above-described procedure (1) was used, and polymerization was conducted in the same manner as in Example 1(3), to obtain a polymer having an excellent powder property. The polymer did not adhere to the inner wall of the autoclave and the stirrer at all.

The polymerization activity was 2600 g polymer/g solid catalyst component/hr. This polymer had 19.5 of SCB, 0.47 of FR, 19.8 of FRR and 8.8 wt % of CXS, namely, small content of lower molecular weight components.

### Example 4

(1) Synthesis of Solid Catalyst Component (I)

Synthesis was conducted in the same manner as in Example 1(2) except that 2.2 ml (9.6 mmol) of di-n-propyl phthalate (hereinafter, abbreviated as DNPP) was used as an ester compound instead of DIBP, to obtain a solid catalyst component (I) having excellent powder property.

The resulting solid product contained 2.6 wt % of Ti.

(2) Polymerization

The solid catalyst component obtained in the above-described procedure (1) was used, and polymerization was carried out in the same manner as in Example 1(3), to obtain a polymer having excellent powder property. The polymer did not adhere to the inner wall of the autoclave and the stirrer at all.

The polymerization activity was 2100 g polymer/g solid catalyst component/hr. This polymer contained 17.3 of SCB, 0.74 of FR, 24.7 of FRR and 7.2 wt % of CXS, namely, small content of lower molecular weight components.

### Example 5

(1) Synthesis of Solid Catalyst Component (I)

Synthesis was carried out in the same manner as in Example 1(2) except that 3.8 ml (9.6 mmol) of di(2-ethylhexyl) phthalate (hereinafter, abbreviated as DEHP) was used as an ester compound instead of DIBP, to obtain a solid catalyst component (I) excellent in powder property.

The resulting solid product contained 1.6 wt % of Ti.

(2) Polymerization

The solid catalyst component obtained in the above-described procedure (1) was used, and polymerization was carried out in the same manner as in Example 1(3), to obtain a polymer having an excellent powder property. The polymer did not adhere to the inner wall of the autoclave and the stirrer at all.

The polymerization activity was 3500 g polymer/g solid catalyst component/hr. This polymer contained 18.7 of SCB, 0.75 of FR, 27.6 of FRR and 6.2 wt % of CXS, namely, small content of lower molecular weight components.

### Example 6

(1) Synthesis of Solid Catalyst Component Precursor (C)

A flask having an inner volume of 1000 ml equipped with a stirrer and dropping funnel was purged with nitrogen, then, 51.0 g of a styrene-divinylbenzene copolymer (average particle size was 37 μm, and volume of micro pores in the range from 100 to 5000 Å of micro pore radius, was 1.05 cc/g) which had been dried at 80° C. for 5 hours, 250 ml of heptane, 47.5 ml (228 mmol) of tetraethoxysilane and 4.5 g (13.2 mmol) of tetra-n-butoxytitanium were charged, and the mixture was stirred at 30° C. for 30 minutes.

Then, 114 ml of n-butylmagnesium chloride (di-n-butyl ether solution 2.1 mol/l) was dropped from a dropping funnel over 1 hour while maintaining the temperature of the flask at 5° C. After completion of the dropping, the mixture was stirred at 5° C. for 1 hour, and additionally stirred for 1 hour at 20° C., then, filtered, washed with 300 ml of hexane three times and dried under vacuum, to obtain 85.2 g of a brown solid product (solid catalyst component precursor (C)).

The resulting solid product contained 5.9 wt % of Mg, 0.42 wt % of Ti, 9.8 wt % of OEt and 0.6 wt % of OBu.

(2) Synthesis of Solid Catalyst Component (I)

A flask having an inner volume of 50 ml equipped with a stirrer and dropping funnel was purged with nitrogen, then, 15.0 ml of toluene, 1.5 ml (13.7 mmol) of TiCl₄ and 0.94 ml (3.5 mmol) of DIBP were charged, and the mixture was stirred at 70° C. for 1 hour. A flask having an inner volume of 100 ml equipped with a stirrer and dropping funnel was purged with nitrogen, then, 30 ml of toluene and 7.80 g of the solid catalyst component precursor (C) synthesized in the above-described procedure (1) were charged, and the mixture was treated at 70° C. for 30 minutes, then, the whole mixture of TiCl₄ and DIBP previously prepared was charged, and the resulted mixture was stirred for 3 hours at 95° C. After stirring, solid-liquid separation was conducted, washed with 44 ml of toluene three times at 95° C., to this 44 ml of toluene was added again. After heated to 70° C., 4.4 ml (40 mmol) of TiCl₄ was added, and the mixture was stirred for 1 hour at 95° C. After stirring, solid-liquid separation was conducted, washed with 44 ml of toluene seven times at 95° C., with 4.4 ml of hexane twice at room temperature, and dried under vacuum to obtain a solid catalyst component (I) excellent in powder property.

The resulting solid product contained 0.77 wt % of Ti.

(3) Polymerization

The solid catalyst component obtained in the above-described procedure (2) was used, and polymerization was carried out in the same manner as in Example 1(3), to obtain a polymer having excellent powder property. The polymer did not adhere to the inner wall of the autoclave and the stirrer at all.

The polymerization activity was 1500 g polymer/g solid catalyst component/hr. This polymer had 17.0 of SCB, 0.94 of FR, 24.6 of FRR and 6.9 wt % of CXS, namely, small content of lower molecular weight components.

### Comparative Example 1

(1) Synthesis of Solid Catalyst Component

A flask having an inner volume of 500 ml equipped with a stirrer was charged 175 ml (1.27 mol Mg/l) of a heptane solution of n-butylethylmagnesium, to this was added dropwise 75 g of tetrachlorosilane at room temperature. After dropping, the mixture was stirred at 60° C. for 2 hours, filtered, washed with 100 ml of heptane seven times, dried under vacuum to obtain 18.0 g of a white solid product.

A flask having an inner vole of 200 ml equipped with a stirrer was charged 1.82 g of the solid product previously prepared, and the mixture was made into slurry with 94 ml of heptane. To this was added 0.95 ml of TiCl₄ at room temperature, the resulting mixture was stirred for 1 hour at 90° C., filtered, washed with 94 ml of heptane five times, and dried under vacuum to obtain 1.66 g of a solid product.

The resulted solid product contained 6.30 wt % of Ti.

(2) Polymerization

An autoclave having a content volume of 3 liter equipped with a stirred was dried thoroughly, and pressure was reduced to vacuum, then, 1.0 kg/cm² (partial pressure) of hydrogen, 650 g of butane and 100 g of 1-butene were charged, and the mixture was heated to 70° C. Then, ethylene was added so that the partial pressure was 6.0 kg/cm². 5.7 millimol of triethylaluminum and 14.2 mg of the solid catalyst component (I) obtained in the above-described procedure (1) were charged with argon pressure, and polymerization was initiated. Then, polymerization was carried out at 70° C. for 2 hours with maintaining the total pressure constant supplying ethylene continuously.

After completion of the polymerization, unreacted monomers were purged, and 136 g of a polymer was obtained.

The polymerization activity was 4800 g polymer/g solid catalyst component/hr. This polymer had 11.5 of SCB, 0.56 of FR, 34.6 of FRR and 5.1 wt % of CXS, namely, though the content of the α-olefin (SCB) was low, while the content of CXS was high.

### Comparative Example 2

The solid catalyst component obtained in Comparative Example 1(1) was used, and polymerization was carried out in the same manner as in Comparative Example 1(2) except that 630 g of butane and 120 g of 1-butene were charged into the autoclave.

The polymerization activity was 5200 g polymer/g solid catalyst component/hr. This polymer had 16.3 of SCB, 0.83 of FR, 34.4 of FRR and 9.0 of CXS, namely, though the content of the α-olefin (SCB) was low, while the content of CXS was high.

### Comparative Example 3

The solid catalyst component obtained in Comparative Example 1(1) was used, and polymerization was carried out in the same manner as in Comparative Example 1(2) except that 610 g of butane and 140 g of 1-butene were charged into the autoclave.

The polymerization activity was 5400 g polymer/g solid catalyst component/hr. This polymer contained 18.7 of SCB, 0.86 of FR, 34.0 of FRR and 10.9 wt % of CXS, namely, though the content of the a -olefin (SCB) was low, while the content of CXS was high.

### Comparative Example 4

(1) Synthesis of Solid Catalyst Component

A flask having an inner volume of 100 ml equipped with a stirrer and dropping funnel was purged with nitrogen, then, 35 ml of toluene and 7.00 g of the solid catalyst component precursor (C) synthesized in Example 1(1) were charged, and the mixture was treated at 70° C. for 30 minutes, then, 3.5 ml (31.9 mmol) of TiCl₄ was charged, the mixture was stirred for 2 hours, solid-liquid separation was conducted, washed with 35 ml of toluene three times at 95° C., and to this 30.8 ml of toluene was added again. Then 4.2 ml (16.0 mmol) of DIBP was added, the mixture was stirred for 1 hour at 95° C., then solid-liquid separation was conducted, washed with 35 ml of toluene three times at 95° C., and to this 35.0 ml of toluene was added again. After heated to 70° C., 3.5 ml (31.9 mmol) of TiCl₄ was added, and the mixture was stirred for 1 hour at 95° C. After stirring, solid-liquid separation was conducted, washed with 35 ml of toluene seven times at 95° C., with 35 ml of hexane twice at room temperature, and dried under vacuum to obtain a solid catalyst component.

The resulted solid product contained 4.1 wt % of Ti.

(2) Polymerization

The solid catalyst component obtained in the above-described procedure (1) was used, and polymerization was conducted in the same manner as in Comparative Example 1(3).

The polymerization activity was 7000 g polymer/g solid catalyst component/hr. This polymer had 20.1 of SCB, 1.04 of FR, 26.0 of FRR and 10.9 wt % of CXS, namely, though the content of the α-olefin (SCB) was low, while the content of CXS was high.

### Comparative Example 5

(1) Synthesis of Solid Catalyst Component

A flask having an inner volume of 500 ml equipped with a stirrer and dropping funnel was purged with nitrogen, then, 346 ml of toluene and 67.2 g of the solid catalyst component precursor (C) synthesized in Example 1(1) were charged, and the mixture was heated to 95° C. Then, 45 ml (168 mmol) of DIBP was added, the mixture was stirred for 30 minutes, then solid-liquid separation was conducted, washed with 340 ml of toluene twice at 95° C., and to this 87 ml of toluene was added again. Then, a mixture of 6.7 ml (39.3 mmol) of di-n-butyl ether, 3.8 ml(14.2 mmol) of DIBP and 134.4 ml (1.23 mol) of TiCl₄ was charged, the mixture was stirred for 3 hours at 95° C., solid-liquid separation was conducted, washed with 340 ml of toluene twice at 95° C., and to this 68 ml of toluene was added again. Then, a mixture of 6.7 ml (39.3 mmol) of di-n-butyl ether and 67.2 ml (612 mmol) of TiCl₄ was charged, the resulting mixture was stirred for 3 hours at 95° C., then solid-liquid separation was conducted, washed with 340 ml of toluene three times at 95° C., with 340 ml of hexane twice at room temperature, and dried under vacuum to obtain a solid catalyst component.

The resulting solid product contained 1.8 wt % of Ti.

(2) Polymerization

The solid catalyst component obtained in the above-described procedure (1) was used, and polymerization was conducted in the same manner as in Example 1(3) except that 600 g of butane and 100 g of 1-butene were charged into the autoclave.

The polymerization activity was 3500 g polymer/g solid catalyst component/hr. This polymer had 20.8 of SCB, 0.98 of FR, 27.0 of FRR and 12.9 wt % of CXS, namely, though the content of the α-olefin (SCB) was low, while the content of CXS was high.

According to the present invention, there are provided a solid catalyst component for olefin polymerization having an excellent particle form, and a catalyst for olefin polymerization having so high polymerization activity per catalyst that removal of a catalyst residue is not necessary, comprising the above-described catalyst component, and by using the catalyst, there can be produced an olefin polymer having an excellent particle property and containing a small amount of a lower molecular weight component.

What is claimed is:

1. A solid catalyst component for olefin polymerization obtained by contacting a titanium compound (A) having a titanium-halogen bond and an ester compound (B) simultaneously, or a mixture of a titanium compound (A) having a titanium-halogen bond and an ester compound (B), with a solid catalyst component precursor (C) containing a magnesium atom, a titanium atom and a hydrocarbyloxy group.

2. The solid catalyst component for olefin polymerization according to claim 1, wherein the solid catalyst component precursor (C) is a solid product obtained by reducing a titanium compound (2) represented by the general formula Ti(OR¹)ₐX₄₋ₐ (wherein R¹ represents a hydrocarbon group having 1 to 20 carbon atoms, X represents a halogen atom, and “a” is a number satisfying 0<a≦4) with an organomagnesium compound (3) in the presence of an organosilicon compound (1) having a Si—O bond.

3. The solid catalyst component for olefin polymerization according to claim 1, wherein the solid catalyst component precursor (C) is a solid product obtained by reducing a titanium compound (2) represented by the general formula Ti(OR¹)ₐX₄₋ₐ (wherein R¹ represents a hydrocarbon group having 1 to 20 carbon atoms, X represents a halogen atom, and “a” is a number satisfying 0<a≦4) with an organomagnesium compound (3) in the presence of an organosilicon compound (1) having a Si—O bond and a porous carrier (4).

4. The solid catalyst component for olefin polymerization according to claim 3, wherein said porous carrier (4) is an organic porous polymer.

5. The solid catalyst component for olefin polymerization according to claims 1, wherein the ester compound (B) is an unsaturated aliphatic carboxylic acid ester or an aromatic carboxylic acid ester.

6. A catalyst for olefin polymerization comprising the catalyst component (I) for olefin polymerization of claim 1 and an organoaluminum compound (II).

7. A method for producing an olefin polymer, which comprises polymerizing an olefin with the catalyst for olefin polymerization of claim 7.

8. The method for producing an olefin polymer according to claim 7, wherein the olefin polymer is a copolymer of ethylene with at least one α-olefin having 3 or more carbon atoms.
